(19) United States
(12) Patent Application Publication
(10) Pub. No.: US 2025/0192157 A1
(43) Pub. Date: Jun. 12, 2025

(54) TECHNIQUES FOR COATING CATHODE MATERIAL AND CREATING ADDITIVES FOR CATHODE COMPOSITES, AND SOLID-STATE BATTERIES INCORPORATING THE SAME

(71) Applicant: Solid Power Operating, Inc., Louisville, CO (US)

(72) Inventors: Jason E. ROBERTS, Denver, CO (US); Megan M. WEBSTER, Denver, CO (US)

(21) Appl. No.: 18/972,402

(22) Filed: Dec. 6, 2024

Related U.S. Application Data
(60) Provisional application No. 63/607,014, filed on Dec. 6, 2023.

(51) Int. Cl. H01M 4/36; H01M 4/02; H01M 4/131; H01M 4/525; H01M 4/62; H01M 10/0562

(52) U.S. Cl. CPC H01M 4/366; H01M 4/131; H01M 4/525; H01M 4/625; H01M 10/0562; H01M 2004/021; H01M 2004/028; H01M 2300/0068

(57) ABSTRACT

Cathode composites for use in solid-state electrochemical cells include a cathode active material that is coated with a metal hydroxide. Additionally, cathode active composites for use in solid- state electrochemical cells include a cathode active material and a metal hydroxide that is distributed throughout the cathode composite. Electrochemical cells that include the cathode composites exhibit improved performance.

### CROSS-REFERENCE TO RELATED APPLICATION

This application is related to and claims priority under 35 U.S.C. § 119 (e) from U.S. Patent Application No. 63/607,014, filed Dec. 6, 2023, titled “Techniques for Coating Cathode Material and Creating Additives for Cathode Composites,” the entire contents of which is incorporated herein by reference for all purposes.

### TECHNICAL FIELD

The present disclosure is directed toward methods of preparing positive electrodes containing cathode active materials. Therefore, the disclosure relates to the fields of batteries, including solid-state batteries, electronics, chemistry, and materials science.

### BACKGROUND

When designing a battery, the type of cathode active material used may have a large impact on the overall energy output of the battery. When a high energy density battery is desired, it is common to select a Nickel-Manganese-Cobalt (NMC) as the cathode active material. However, the NMC material may be highly reactive to its surroundings; thus, it is common practice to fully coat the NMC cathode materials with a uniform layer of a metal oxide such as Al₂O₃. The standard coating process used for this purpose is Atomic Layer Deposition (ALD) or a sol-gel method. Both techniques, however, require specialized equipment and possibly high temperatures to form the desired coating.

Among other things, what is needed are methods for preparing cathode active materials, especially NMC cathode active materials, that produce a material that is stable in a wide variety of environments and that do not require highly specialized equipment and/or large amounts of energy. It is with these observations in mind, among others, that aspects of the present disclosure were conceived.

### SUMMARY

Provided herein are cathode active materials partially or fully coated by a metal hydroxide. The cathode active material has a surface, wherein at least 5% of the surface is coated by the metal hydroxide. In some examples, the metal hydroxide includes lithium hydroxide or zirconium hydroxide.

Further provided herein are cathode composites that include a conductive additive, a solid electrolyte material, a metal hydroxide, and a cathode active material. The cathode active material is in the form of particles and each of the particles has a surface, and at least 5% of the surface of the cathode active material particles is coated by the metal hydroxide. Alternatively or additionally, the metal hydroxide is distributed throughout the cathode composite. In some aspects, the conductive additive is also coated by a metal hydroxide.

Further provided herein are solid-state batteries the include the cathode active materials and the cathode composites of the present disclosure.

Further provided herein are methods for making the cathode composites of the present disclosure. The methods include combining a cathode active material and a metal hydroxide, wherein the cathode active material is in the form of particles and each of the particles has a surface, and wherein at least 5% of the surface of the cathode active material particles is coated by the metal hydroxide as a result of the combining; and combining the coated cathode active material with a conductive additive, a solid electrolyte, and a binder to form a cathode composite. The methods also include combining a cathode active material, a metal hydroxide, a conductive additive, a solid electrolyte, and a binder to form the cathode composite, wherein the combining results in the metal hydroxide being dispersed throughout the cathode composite. The methods also include combining a cathode active material and a metal hydroxide, wherein the cathode active material is in the form of particles and each of the particles has a surface, and wherein at least 5% of the surface of the cathode active material particles is coated by the metal hydroxide as a result of the combining; and combining the coated cathode active material with a conductive additive, a solid electrolyte, a binder and an additional amount of the metal hydroxide to form a cathode composite.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1. A graph showing a cell's capacity (mAh/g) vs number of cycles for Example 1 and Example 3.

FIG. 2. A graph showing a cell's capacity (mAh/g) vs number of cycles for Example 1 and Example 2.

FIG. 3. A graph showing a cell's capacity (mAh/g) vs number of cycles for a cathode composite made in Example 4, Example 5, Example 6, and Example 7.

FIG. 4. A graph showing a cell's capacity (mAh/g) vs number of cycles for a cathode composite made in Example 8 and Example 9.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximμm. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

The current application is directed to the integration of a metal hydroxide into a cathode composite containing a cathode active material where the cathode composite is used to make a solid-state electrochemical cell. In one scenario, the integration of the metal hydroxide into the cathode composite occurs by coating the surface of the cathode. In another example, the integration of the metal hydroxide into the cathode composite occurs by adding the metal hydroxide as an additive to the cathode composite. Both approaches have been shown to have the surprising effect of increasing the electrochemical stability of an uncoated cathode material when in close proximity to sulfide solid electrolyte materials.

### Hydroxide Coating Approach and Related Cathode Active Material

Described herein are coated cathode active materials and methods for applying said coating for use in making an electrochemical cell, which in some cases may be considered a solid-state battery cell. The inventors conceived of and discovered that by mixing a cathode active material and a metal hydroxide together before mixing with any other materials forming a cathode composite, the metal hydroxide can partially or fully coat the cathode active material particles. Surprisingly, this effectively increases the particle size of the cathode active material particles without reducing the ionic conductivity of the cathode active material, thereby improving stability and capacity of an electrochemical cell that incorporates a cathode including the cathode active material.

The cathode active material may include a Nickel-Manganese-Cobalt (NMC) material and may be represented by the formula LiNiₐMn_{b}Co_{c}O₂, wherein 0<a<1, 0<b<1, 0<c<1 and a+b+c =1. In some cases, the cathode active material may include NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or any combination thereof.

In another embodiment, the cathode active material may include a metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1) , Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂(021 a<1, 0<b<1, 0<c<1, a+b+c=1), or any combination thereof. In yet another embodiment, the cathode active material may include a metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or any combination thereof. In still further embodiments, the cathode active material may include elemental sulfur(S). In additional embodiments, the cathode active material may includes a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AIF₃), and zirconium (IV) fluoride (ZrF₄), or any combination thereof.

The cathode active material may be in the form of particles, such as a powder or other granulated material.

The metal hydroxide may include an alkali metal hydroxide, an alkaline earth metal hydroxide, a transition metal hydroxide, a post-transition metal hydroxide, and any combination thereof. Transition metal hydroxides refer to hydroxide salts of transition metals found in groups 3-12 of the period table. Post-transition metal hydroxides refer to hydroxide salts of post-transition metals (also referred to as semimetals) in groups 13-16 of the periodic table.

Nonlimiting examples of alkali metal hydroxides include lithium hydroxide, sodium hydroxide, potassium hydroxide, rubidium hydroxide, and cesium hydroxide.

Nonlimiting examples of alkaline earth metal hydroxides include magnesium hydroxide, calcium hydroxide, strontium hydroxide, and barium hydroxide.

Nonlimiting examples of transition metal hydroxides include zirconium (IV) hydroxide, zinc (II) hydroxide, niobium hydroxide, nickel (II) hydroxide, cobalt (II) hydroxide, manganese (II) hydroxide, and other transition metal hydroxides known in the art.

Nonlimiting examples of post-transition metals include aluminum hydroxide, tin hydroxide, indium hydroxide, and other post-transition metal hydroxides known in the art.

In some examples, the metal hydroxide includes lithium hydroxide.

The cathode active material particles may be coated with the metal hydroxide such that at least 5% of the surface of the cathode active material particles are coated by the metal hydroxide. For example, the cathode active material particles may be coated with the metal hydroxide such that from about 5% to about 100%, from about 5% to about 75%, from about 5% to about 50%, from about 5% to about 25%, from about 25% to about 100%, from about 50% to about 100%, from about 75% to about 100%, or from about 25% to about 75% of the surface of the cathode active material particles are coated by the metal hydroxide. As another example, the cathode active material particles may be coated with the metal hydroxide such that about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the surface of the cathode active material particles are coated by the metal hydroxide.

The metal hydroxide coating on the cathode active material particles may have a uniform thickness or the thickness may vary. The maximum thickness of the lithium containing metal hydroxide coating may be less than half the average diameter of cathode active material particles. For example, the coating may have a thickness from about 0.1 μm to about 10 μm, such as from about 0.1 μm to about 0.25 μm, about 0.1 μm to about 0.5 μm, about 0.1 μm to about 0.75 μm, about 0.1 μm to about 1 μm, about 0.1 μm to about 2.5 μm, about 0.1 μm to about 5 μm, about 0.1 μm to about 7.5 μm, about 0.1 μm to about 10 μm, about 0.25 μm to about 10 μm, about 0.5 μm to about 10 μm, about 0.75 μm to about 10 μm, about 1 μm to about 10 μm, about 2.5 μm to about 10 μm, about 5 μm to about 10 μm, about 7.5 μm to about 10 μm, about 0.5 μm to about 5 μm, or about 0.75 μm to about 2.5 μm. As another example, the coating may have a thickness of about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 2 μm, about 3 μm, about 4 μm, about 5 μm, about 6 μm, about 7 μm, about 8 μm, about 9 μm, or about 10 μm.

The metal hydroxide may be applied to the surface of the cathode active material particles by combining the cathode active material and the metal hydroxide, and mixing, grinding, stirring, tumbling, or sheering the cathode active material and metal hydroxide particles. Methods and apparatuses to accomplish the mixing, grinding, stirring, tumbling, or sheering are generally known to those having ordinary skill in the art. The time of mixing, grinding, stirring, tumbling, or sheering is not particularly limited so long as the desired distribution of the metal hydroxide is achieved. The time of mixing, grinding, stirring, tumbling, or sheering may take place for a period of from 1 minute to 48 hours. The temperature of the mixing, grinding, stirring, tumbling, or sheering may be from about −20° C. to about 200° C. The mixing, grinding, stirring, tumbling, or sheering may be conducted in an inert atmosphere, such as nitrogen, argon, or hydrogen. Alternatively, the mixing, grinding, stirring, tumbling, or sheering may be conducted under vacuum.

The cathode active material and the metal hydroxide may be combined with a solvent during the mixing, grinding, stirring, tumbling, or sheering. The solvent may include a hydrocarbon solvent, an ester solvent, an ether solvent, a nitrile solvent, or any combination thereof.

When the cathode active material is sufficiently coated, the coated cathode active material may be incorporated into a cathode composite by mixing, grinding, stirring, tumbling, or sheering the cathode conductive material and the metal hydroxide with a sulfide-based solid electrolyte, a conductive additive, and a binder. Methods and apparatuses to accomplish the mixing, grinding, stirring, tumbling, or sheering are generally known to those having ordinary skill in the art. The time of mixing, grinding, stirring, tumbling, or sheering is not particularly limited so long as the desired distribution of the metal hydroxide is achieved. The time of mixing, grinding, stirring, tumbling, or sheering may take place for a period of from 1 minute to 48 hours. The temperature of the mixing, grinding, stirring, tumbling, or sheering may be from about −20° C. to about 200° C. The mixing, grinding, stirring, tumbling, or sheering may be conducted in an inert atmosphere, such as nitrogen, argon, or hydrogen. Alternatively, the mixing, grinding, stirring, tumbling, or sheering may be conducted under vacuum.

During the mixing, grinding, stirring, tumbling, or sheering, the metal hydroxide may be present in an amount from about 0.5 wt % to about 20 wt % of the combined weight of the cathode active material and the metal hydroxide. For example, the metal hydroxide may be present in an amount from about 0.5 wt % to about 1 wt %, about 0.5 wt % to about 5 wt %, about 0.5 wt % to about 10 wt %, about 0.5 wt % to about 15 wt %, about 0.5 wt % to about 20 wt %, about 1 wt % to about 20 wt %, about 5 wt % to about 20 wt %, about 10 wt % to about 20 wt %, about 15 wt % to about 20 wt %, about 1 wt % to about 10 wt %, or about 1 wt % to about 5 wt % of the combined weight of the cathode active material and the metal hydroxide. As another example, the metal hydroxide may be present in an amount of about 0.1 wt %, about 0.2 wt %, about 0.3wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt % of the combined weight of the cathode active material and the metal hydroxide.

The solid electrolyte may be a sulfide-based solid electrolyte may be one within the Argyrodite family which can be represented by the following formula: Li_{(7-A-B)}PS_{(6-A-B)}X_{A}Y_{B}, where X and Y may be one or more halogen (F, CI, Br, I), 0≤A≤2, 0≤B≤2, and where A+B≤2. Examples of these may be Li₆PS₅Cl, Li₆PS₅Br, Li₆PS₅I, Li_{5.5}PS_{4.5}Cl_{1.5}, or Li_{5.5}PS_{4.5}BrCl_{0.5}.

In some embodiments, the sulfide-based solid electrolyte may include Li₂S—P₂S₅, Li₂S—P₂S₅—Lil, Li₂S—P₂S₅—GeS₂, Li2ₛ—P₂S₅—Li₂O, Li₂S—P₂S₅—Li₂O—Lil, Li₂S—P₂S₅—Lil—LiBr, Li₂S—SiS₂, Li₂S—SiS₂—Lil, Li₂S—SiS₂—LiBr, Li₂S—S—SiS₂—LiCl, Li₂S—S—SiS₂—B₂S₃—Lil, Li₂S—S—SiS₂—P₂S₅—Lil, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, Li₂S—S—SiS₂-LiₓMO_{y} (where x and y are positive numbers, and M is P, Si, Ge, B, Al, Ga or In), or any combination thereof. Halide solid electrolytes may have the structure Li-M-X, M is a metal element, and X is a halogen. These can be expressed by the generic formula LigM⁴⁺_{β}N³⁺_{(1-β)}X_{Ω}Y_{(6-Ω)}, where: 0≤β≤1; 0≤Ω≤6; α=6-[(β*4)+(1-β)*3]; X and Y are each independently a halogen selected from the group consisting of F, CI, Br, and I; M is an element with an oxidation state of 4+ such as Ti, Zr, Hf, and Rf; and N is an element an oxidation state of 3+ such as Ga, In, and TI, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In yet another embodiment, the sulfide-based solid electrolyte may include Li₃PS₄, Li₄P₂S₆, Li₇P₃S₁₁, Li₁₀GeP₂S₁₂, Li₁₀SnP₂S₁₂, or any combination thereof. In a further embodiment, the solid electrolyte material may be one or more of a Li₆PS5CI, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, CI, Br, I, and the pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, CI, Br, I, and the pseudo-halogen may be one or more of N, NH, NH₂, NO, NO₂, BF₄, BH₄, AlH₄, CN, and SCN.

The sulfide-based solid electrolyte may be present in the cathode composite in an amount from greater than 0% to about 60% by weight; for example, the sulfide-based solid electrolyte may be present in the cathode composite in an amount from greater than 0% to about 10% by weight, greater than 0% to about 20% by weight, greater than 0% to about 30% by weight, greater than 0% to about 40% by weight, greater than 0% to about 50% by weight, about 10% to about 60% by weight, about 20% to about 60% by weight, about 30% to about 60% by weight, about 40% to about 60% by weight, or about 50% to about 60% by weight. In some aspects, the sulfide-based solid electrolyte may be present in the cathode composite in an amount of about 5%, 10%, 15%, 20%, 25%, 30%, 35%, 40%, 45%, 50%, 55%, or 60% by weight of the anode layer. In an example, the sulfide-based solid electrolyte is present in the cathode composite in an amount from about 35% to about 45% by weight.

In some embodiments, the average particle size of the sulfide-based solid electrolyte material may be from about 100 nm to about 50 μm. In some aspects, the average particle size of the sulfide-based solid electrolyte may be about from 200 nm to about 40 μm, about 500 nm to about 30 μm, about 600 nm to about 30 μm, about 700 nm to about 25 μm, about 800 nm to about 20 μm, about 800 nm to about 15 μm, about 800 nm to about 15 μm, about 800 nm to about 10μm, about 800 nm to about 9 μm, about 100 nm to about 10 μm, about 200 nm to about 10 μm, about 400 nm to about 10 μm, about 600 nm to about 10 μm, about 800 nm to about 10 μm, about 1 μm to about 10 μm, about 1.25 μm to about 10 μm, about 1.5 μm to about 10 μm, about 2 um to about 10 μm, about 2.25 μm to about 9 μm, or about 2.5 μm to about 8 μm. In some embodiments, the sulfide-based solid electrolyte may have a particle size of about 100 nm, 200nm, 300 nm, 400 nm, 500 nm, 600 nm, 700 nm, 800 nm, 900 nm, 1 μm, 2 μm, 3 μm, 4 μm, 5 μm, 6 μm, 8 μm, 10 μm, 15 μm, 25 μm, or about 50 μm. The average particle size (e.g., D50) may be determined through any method known to those having ordinary skill in the art.

The conductive additive may include one or more conductive carbon materials such as carbon fiber, graphite, graphene, carbon black, conductive carbon, amorphous carbon, vapor grown carbon fiber (VGCF), activated carbon, and carbon nanotubes.

The conductive additive may alternatively or additionally include metal powders, fibers, filaments, or any other material known to conduct electrons.

The conductive additive may be present in the cathode composite in an amount from greater than 0% to about 15% by weight of the cathode composite. In some aspects, the conductive additive may be present in the cathode composite in an amount from greater than 0% to about 10%, or greater than 0% to about 5% by weight. In some additional aspects, the conductive additive may be present in the cathode composite in an amount of about 0%, 1%, 2%, 3%, 4%, 5%, 6%, 7%, 8%, 9%, 10%, 11%, 12%, 13%, 14%, or about 15% by weight. In an example embodiment, the conductive additive is present in the cathode composite in an amount from greater than 0% to about 5% by weight.

The average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., D₅₀) may be determined through any method known to those having ordinary skill in the art.

In some scenarios, it may be advantageous to include one or more binders in the cathode composite. The binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another example, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. Another approach would be to have the binder be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like.

The binder may be present in the cathode composite in an amount from about 1% to about 40% by weight of the cathode composite. For example, the binder may be present in the cathode composite in an amount from about 1% to about 5%, about 1% to about 10%, about 1% to about 15%, about 1% to about 20%, about 1% to about 25%, about 1% to about 30%, about 1% to about 35%, about 1% to about 40%, about 5% to about 40%, about 10% to about 40%, about 15% to about 40%, about 20% to about 40%, about 25% to about 40%, about 30% to about 40%, about 35% to about 40%, about 5% to about 15%, about 5% to about 20%, about 10% to about 15%, about 10% to about 20%, or about 15% to about 20% by weight of the cathode composite. As another example, the binder may be present in the cathode composite in an amount of about 1%, about 5%, about 10%, about 15%, about 20%, about 25%, about 30%, about 35%, or about 40% by weight of the cathode composite.

The metal hydroxide may be present in the cathode composite in an amount from about 0.1 wt % to about 15 wt % by total weight of the cathode composite. For example, the metal hydroxide may be present in the cathode composite in an amount from about 0.1 wt % to about 0.5 wt %, about 0.1 wt % to about 1 wt %, about 0.1 wt % to about 5 wt %, about 0.1 wt % to about 10 wt %, about 0.1 wt % to about 15 wt %, about 0.5 wt % to about 15 wt %, about 1 wt % to about 15 wt %, about 5 wt % to about 15 wt %, or about 10 wt % to about 15 wt % by total weight of the cathode composite. As another example, the metal hydroxide may be present in the cathode composite in an amount of about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or about 15 wt % by total weight of the cathode composite.

The cathode composite made by this method may then be formed into a cathode layer and incorporated into an electrochemical cell, such as a solid-state battery.

In some embodiments, the conductive additive may also be coated by the metal hydroxide in the same manner as described above with respect to the cathode active material. The metal hydroxide may be applied to the surface of the conductive additive particles by combining the conductive additive and the metal hydroxide, and mixing, grinding, stirring, tumbling, or sheering the conductive additive and metal hydroxide particles. Methods and apparatuses to accomplish the mixing, grinding, stirring, tumbling, or sheering are generally known to those having ordinary skill in the art. The time of mixing, grinding, stirring, tumbling, or sheering is not particularly limited so long as the desired distribution of the metal hydroxide is achieved. The time of mixing, grinding, stirring, tumbling, or sheering may take place for a period of from 1 minute to 48 hours. The temperature of the mixing, grinding, stirring, tumbling, or sheering may be from about −20° C. to about 200° C. The mixing, grinding, stirring, tumbling, or sheering may be conducted in an inert atmosphere, such as nitrogen, argon, or hydrogen. Alternatively, the mixing, grinding, stirring, tumbling, or sheering may be conducted under vacuum.

The conductive additive and the metal hydroxide may be combined with a solvent during the mixing, grinding, stirring, tumbling, or sheering. The solvent may include a hydrocarbon solvent, an ester solvent, an ether solvent, a nitrile solvent, or any combination thereof.

The conductive additive particles may be coated with the metal hydroxide such that at least 5% of the surface of the conductive additive particles are coated by the metal hydroxide. For example, the conductive additive particles may be coated with the metal hydroxide such that from about 5% to about 100%, from about 5% to about 75%, from about 5% to about 50%, from about 5% to about 25%, from about 25% to about 100%, from about 50% to about 100%, from about 75% to about 100%, or from about 25% to about 75% of the surface of the conductive additive particles are coated by the metal hydroxide. As another example, the conductive additive particles may be coated with the metal hydroxide such that about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the surface of the conductive additive particles are coated by the metal hydroxide.

When the conductive additive is sufficiently coated, the coated conductive additive may be incorporated into a cathode composite by mixing, grinding, stirring, tumbling, or sheering the conductive additive and the metal hydroxide with a sulfide-based solid electrolyte, a conductive additive, a cathode active material, and a binder. Methods and apparatuses to accomplish the mixing, grinding, stirring, tumbling, or sheering are generally known to those having ordinary skill in the art. The time of mixing, grinding, stirring, tumbling, or sheering is not particularly limited so long as the desired distribution of the metal hydroxide is achieved. The time of mixing, grinding, stirring, tumbling, or sheering may take place for a period of from 1 minute to 48 hours. The temperature of the mixing, grinding, stirring, tumbling, or sheering may be from about −20° C. to about 200° C. The mixing, grinding, stirring, tumbling, or sheering may be conducted in an inert atmosphere, such as nitrogen, argon, or hydrogen. Alternatively, the mixing, grinding, stirring, tumbling, or sheering may be conducted under vacuum.

### Hydroxide Additive Approach

Further described herein are cathode active material composites that include a metal hydroxide additive for enhanced electrochemical stability. The inventors conceived of and surprisingly discovered that by incorporating a metal hydroxide into a cathode composite containing an uncoated cathode active material, a stabilizing effect is produced whereby the cathode active material has increased stability against sulfide-based solid electrolytes. By mixing the metal hydroxide with all the other components of the cathode composite, the lithium hydroxide is distributed throughout the cathode composite rather than being coated onto the cathode active material as in the approach described above.

The cathode composite includes a cathode active material, a metal hydroxide, a sulfide-based solid electrolyte, a conductive additive, and a binder. The cathode active material, metal hydroxide, sulfide-based solid electrolyte, conductive additive, and binder may be any of those described above.

The metal hydroxide may contact the cathode active material particles in the cathode composite, thereby covering a small portion of the surface of the cathode active material particles. The metal hydroxide may cover less than 5% of the surface of the cathode active material particles in this embodiment. In the cathode composite, it may be preferred to have the particle size of the metal hydroxide material be greater than that of the cathode active material. In some cases, it may be preferred to have the particle size of the metal hydroxide less than the particle size of the cathode active material.

The cathode active material may have an average particle size from about 0.5 μm to about 20 μm. For example, the cathode active material may have an average particle size from about 0.5 μm to about 1 μm, about 0.5 μm to about 5 μm, about 0.5 μm to about 10 μm, about 0.5 μm to about 15 μm, about 0.5 μm to about 20 μm, about 1 μm to about 20 μm, about 5 μm to about 20 μm, about 10 μm to about 20 μm, or about 15 μm to about 20 μm. As another example, the average particle size may be about 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or about 20 μm. The average particle size (i.e., D50) may be determined using commonly known methods and apparatuses, such as a Mastersizer 3000 particle size analyzer.

The metal hydroxide may have an average particle size from about 0.1 μm to about 25 μm. For example, the metal hydroxide may have an average particle size from about 0.1 um to about 0.5 μm, about 0.1 μm to about 1 μm, about 0.1 μm to about 5 μm, about 0.1 μm to about 10 μm, about 0.1 μm to about 15 μm, about 0.1 μm to about 20 μm, about 0.1 μm to about 25μm, about 0.5 μm to about 25 μm, about 1 μm to about 25 μm, about 5 μm to about 25 μm, about 10 μm to about 25 μm, about 15 μm to about 25 μm, or about 20 μm to about 25 μm. As another example, the metal hydroxide may have an average particle size of about 0.1 μm, 0.2 μm, 0.3μm, 0.4 μm, 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, or about 25 μm. The average particle size (i.e., D50) may be determined using commonly known methods and apparatuses, such as a Mastersizer 3000 particle size analyzer.

In the areas where the metal hydroxide is in contact with the cathode active material particles, the metal hydroxide may form a layer on the cathode active material particle from 0.1 to 50 μm. For example, the layer may have a thickness from about 0.1 μm to about 50 μm, such as from about 0.1 μm to about 0.5 μm, about 0.1 μm to about 1 μm, about 0.1 μm to about 5 μm, about 0.1 μm to about 10 μm, about 0.1 μm to about 25 μm, about 0.1 μm to about 50 μm, about 0.5 μm to about 50 μm, about 1 μm to about 50 μm, about 5 μm to about 50 μm, about 10 μm to about 50 μm, or about 25 μm to about 50 μm. As another example, the layer may have a thickness of about 0.1 μm, 0.25 μm, 0.5 μm, 0.75 μm, 1 μm, 2.5 μm, 5 μm, 7.5 μm, 10 μm, 15 μm, 20 μm, 25 μm, 30 μm, 35 μm, 40 μm, 45 μm, or about 50 μm.

In some embodiments, less than 5% of the metal hydroxide is in physical contact with the cathode active material particles in the cathode composite. This may be determined by scanning electron microscopy (SEM) imaging of a cross-section of the cathode composite. In further embodiments, less than 10% of the metal hydroxide is in contact with the cathode active material. In another embodiment, less than 15%, less than 20%, less than 25%, less than 30%, less than 40%, less than 50%, less than 60%, less than 70% of the metal hydroxide is in contact with the cathode active material. In still further embodiments, less than 5%, less than 4%, less than 3%, less than 2%, or less than 1% of the metal hydroxide is in physical contact with the cathode active material particles in the cathode composite.

The metal hydroxide may be incorporated in the cathode composite by mixing, grinding, stirring, tumbling, or sheering the components of the cathode composite (i.e., the cathode active material, the metal hydroxide, the sulfide-based solid electrolyte, the conductive additive, and the binder). Methods and apparatuses to accomplish the mixing, grinding, stirring, tumbling, or sheering are generally known to those having ordinary skill in the art. In contrast with the coated cathode compositions above where the metal hydroxide and the cathode active material are mixed before the remaining components of the cathode composite are added, in this embodiment the metal hydroxide and cathode active material are mixed with all other components of the cathode composite at the same time.

The metal hydroxide may be present during the mixing in an amount from about 0.1 wt % to about 15 wt % by total weight of the components of the cathode composite. Accordingly, the cathode composite includes the metal hydroxide in an amount from about 0.1 wt % to about 15 wt %. For example, the metal hydroxide may be present during the mixing in an amount from about 0.1 wt % to about 0.5 wt %, about 0.1 wt % to about 1 wt %, about 0.1 wt % to about 5 wt %, about 0.1 wt % to about 10 wt %, about 0.1 wt % to about 15 wt %, about 0.5 wt % to about 15 wt %, about 1 wt % to about 15 wt %, about 5 wt % to about 15 wt %, or about 10 wt % to about 15 wt % by total weight of the components of the cathode composite. As another example, the metal hydroxide may be present during the mixing in an amount of about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or about 15 wt % by total weight of the components of the cathode composite.

The time of mixing, grinding, stirring, tumbling, or sheering is not particularly limited so long as the desired distribution of the metal hydroxide is achieved. The time of mixing, grinding, stirring, tumbling, or sheering may take place for a period of from 1 minute to 48 hours. The temperature of the mixing, grinding, stirring, tumbling, or sheering may be from about −20° C. to about 200° C. The mixing, grinding, stirring, tumbling, or sheering may be conducted in an inert atmosphere, such as nitrogen, argon, or hydrogen. Alternatively, the mixing, grinding, stirring, tumbling, or sheering may be conducted under vacuum.

The cathode composite components may be combined with a solvent during the mixing, grinding, stirring, tumbling, or sheering. The solvent may include a hydrocarbon solvent, an ester solvent, an ether solvent, a nitrile solvent, or any combination thereof.

The cathode composite made by this method may then be formed into a cathode layer and incorporated into an electrochemical cell, such as a solid-state battery.

### Combined Approach

The hydroxide coating and hydroxide additive approaches described above may be combined into a single combined approach.

In the combined approach, the metal hydroxide and the cathode active material may be combined alone first to coat the cathode active material with the metal hydroxide as described above with respect to the hydroxide coating approach. The combining may include mixing, grinding, stirring, tumbling, or sheering as described above. The time of mixing, grinding, stirring, tumbling, or sheering is not particularly limited so long as the desired distribution of the metal hydroxide is achieved. The time of mixing, grinding, stirring, tumbling, or sheering may take place for a period of from 1 minute to 48 hours. The temperature of the mixing, grinding, stirring, tumbling, or sheering may be from about −20° C. to about 200° C. The mixing, grinding, stirring, tumbling, or sheering may be conducted in an inert atmosphere, such as nitrogen, argon, or hydrogen. Alternatively, the mixing, grinding, stirring, tumbling, or sheering may be conducted under vacuum. A solvent may be added during this step as described above.

Then, the other components of the cathode composite (the binder, the conductive additive, and the sulfide-based solid electrolyte as described above) are added to the coated cathode active material, as well as additional metal hydroxide. All of the components of the cathode composite are then mixed as described above with respect to the hydroxide additive approach, thereby dispersing the metal hydroxide throughout the cathode composite. The combining in this embodiment may cause portions of the metal hydroxide coating the cathode active material to break off of the cathode active material, which are then dispersed throughout the cathode composite.

The combining may include mixing, grinding, stirring, tumbling, or sheering as described above. The time of mixing, grinding, stirring, tumbling, or sheering is not particularly limited so long as the desired distribution of the metal hydroxide is achieved. The time of mixing, grinding, stirring, tumbling, or sheering may take place for a period of from 1 minute to 48 hours. The temperature of the mixing, grinding, stirring, tumbling, or sheering may be from about −20° C. to about 200° C. The mixing, grinding, stirring, tumbling, or sheering may be conducted in an inert atmosphere, such as nitrogen, argon, or hydrogen. Alternatively, the mixing, grinding, stirring, tumbling, or sheering may be conducted under vacuum. A solvent may be added during this step as described above.

The cathode composite made by this method may then be formed into a cathode layer and incorporated into an electrochemical cell, such as a solid-state battery.

### Forming A Cathode Layer for Use in an Electrochemical Cell

The cathode composite made by any of the methods described above may be formed into a cathode layer and incorporated into an electrochemical cell such as a solid-state battery.

The cathode composite is combined with a solvent to form a cathode slurry. The solvent may include a hydrocarbon solvent. The solvent may include a hydrocarbon solvent, an ester solvent, an ether solvent, a nitrile solvent, or any combination thereof.

The slurry may then be cast onto a current collector. The current collector may include copper, aluminum, nickel, titanium, stainless steel, magnesium, iron, zinc, indium, germanium, silver, platinum, gold, or any combination thereof. The current collector may further comprise a carbon coating onto which the slurry is cast. In some embodiments, the current collector may have a thickness from about 5 μm to about 10 μm.

The slurry may be dried. The drying may be accomplished simply by allowing the solvent to evaporate from the slurry at room temperature, or the cast slurry may be heated to evaporate the solvent more quickly. The drying may also be conducted under vacuum to further remove any residual solvent. The drying may be accomplished using a furnace, oven, vacuum oven, or other apparatuses known in the art.

Once the slurry is dried, it is cut to form a cathode layer positive electrode. The cathode layer is stacked with a separator layer and an anode layer to form an electrochemical cell.

### Enumerated Embodiments

Embodiment 1: A cathode active material having a surface, wherein at least 5% of the surface is coated by a metal hydroxide.

Embodiment 2: The cathode active material of embodiment 1, where the cathode active material comprises a nickel-manganese-cobalt (NMC) cathode active material.

Embodiment 3: The cathode active material of embodiment 1 or 2, wherein the metal hydroxide comprises lithium hydroxide or zirconium hydroxide.

Embodiment 4: The cathode active material of any one of embodiments 1-3, wherein at least 50% of the surface of the cathode active material is coated by the metal hydroxide.

Embodiment 5: The cathode active material of any one of embodiments 1-4, wherein the surface of the cathode active material is fully coated by the metal hydroxide.

Embodiment 6: A cathode composite comprising a conductive additive, a solid electrolyte material, a metal hydroxide, and a cathode active material, wherein the metal hydroxide is distributed throughout the cathode composite.

Embodiment 7: The cathode composite of embodiment 6, where the conductive additive comprises carbon.

Embodiment 8: The cathode composite of embodiment 6 or 7, wherein the solid electrolyte material is an Argyrodite sulfide-based solid electrolyte.

Embodiment 9: The cathode composite of any one of embodiments 6-8, further comprising a binder.

Embodiment 10: The cathode composite of any one of embodiments 6-9, wherein the cathode active material is in the form of particles and each of the particles has a surface, and at least 5% of the surface of the cathode active material particles is coated by the metal hydroxide.

Embodiment 11: The cathode composite of embodiment 10, wherein at least 15% of the surface of the cathode active material particles is coated by a lithium containing metal hydroxide.

Embodiment 12: The cathode composite of embodiment 10, wherein at least 25% of the surface of the cathode active material particles is coated by a lithium containing metal hydroxide.

Embodiment 13: The cathode composite of embodiment 10, wherein at least 50% of the surface of the cathode active material particles is coated by a lithium containing metal hydroxide.

Embodiment 14: The cathode composite of any one of embodiments 6-13, wherein the conductive additive is in the form of particles and each of the particles has a surface, wherein at least 5% of the surface of the conductive additive particles is coated by the metal hydroxide.

Embodiment 15: The cathode composite of any one of embodiments 6-14, wherein the metal hydroxide has an average particle size of 10 μm or less.

Embodiment 16: The cathode composite of any one of embodiments 6-15, where the metal hydroxide has an average particle size of 5 μm or less.

Embodiment 17: The cathode composite of any one of embodiments 6-16, where the metal hydroxide has an average particle size of 1 μm or less.

Embodiment 18: The cathode composite of any one of embodiments 6-17, wherein the cathode active material comprises a nickel-manganese-cobalt (NMC) cathode active material.

Embodiment 19: The cathode composite of any one of embodiments 6-18, wherein the solid electrolyte comprises an Argyrodite sulfide-based solid electrolyte.

Embodiment 20: A solid-state battery comprising the cathode composite of any one of embodiments 6-19.

Embodiment 21: A solid state battery comprising a cathode composite, the cathode composite comprising a conductive additive, a solid electrolyte material, a metal hydroxide, and a cathode active material, wherein the metal hydroxide is distributed throughout the cathode composite.

Embodiment 22: The solid state battery of embodiment 21, where the conductive additive comprises carbon.

Embodiment 23: The solid state battery of embodiment 21 or 22, where the solid electrolyte material comprises an Argyrodite sulfide-based solid electrolyte.

Embodiment 24: The solid state battery of any one of embodiments 21-23, wherein the cathode active material is in the form of particles and each of the particles has a surface, and at least 5% of the surface of the cathode active material particles is coated by the metal hydroxide.

Embodiment 25: The solid state battery of any one of embodiments 21-24, wherein the cathode active material comprises a nickel-manganese-cobalt (NMC) cathode active material.

Embodiment 26: The solid state battery of any one of embodiments 21-25, wherein the cathode composite further comprises a binder.

Embodiment 27: A method for making a cathode composite comprising:

combining a cathode active material and a metal hydroxide, wherein the cathode active material is in the form of particles and each of the particles has a surface, and wherein at least 5% of the surface of the cathode active material particles is coated by the metal hydroxide as a result of the combining; and combining the coated cathode active material with a conductive additive, a solid electrolyte, and a binder to form a cathode composite.

Embodiment 28: A method for making a cathode composite comprising: combining a cathode active material, a metal hydroxide, a conductive additive, a solid electrolyte, and a binder to form the cathode composite, wherein the combining results in the metal hydroxide being dispersed throughout the cathode composite.

Embodiment 29: The method of embodiment 28, wherein the cathode active material is coated by a metal hydroxide prior to the combining.

Embodiment 30: A method for making a cathode composite comprising:

combining a cathode active material and a metal hydroxide, wherein the cathode active material is in the form of particles and each of the particles has a surface, and wherein at least 5% of the surface of the cathode active material particles is coated by the metal hydroxide as a result of the combining; and combining the coated cathode active material with a conductive additive, a solid electrolyte, a binder and an additional amount of the metal hydroxide to form a cathode composite.

### EXAMPLES

### Example 1

A cathode composite was made containing 66.2 wt % NMC cathode active material, 2.5 wt % carbon conductive additive, 30.5 wt % sulfide-based solid electrolyte material, and 0.8wt % LiOH powder. The NMC cathode material and LiOH were added into a mortar and pestle. These two materials were mixed with the pestle for a few minutes after which all the remaining materials were added to the same mortar. All the materials were then mixed with the pestle for several minutes. The cathode composite was then incorporated into an electrochemical cell.

### Example 2—Comparative

A cathode composite was made containing 66.2 wt % NMC cathode active material, 2.5 wt % carbon conductive additive, 30.5 wt % sulfide-based solid electrolyte material (the same as used in Example 1), and 0.8 wt % Li₂CO₃ powder. The NMC cathode material and Li₂CO₃ were added into a mortar and pestle. These two materials were mixed with the pestle for a few minutes after which all the remaining materials were added to the same mortar. All the materials were then mixed with the pestle for several minutes. The cathode composite was then incorporated into an electrochemical cell.

### Example 3—Comparative—No Cathode Coating

A cathode composite was made containing 67 wt % NMC cathode active material, 2.5 wt % carbon conductive additive, and 30.5 wt % sulfide-based solid electrolyte material (the same as used in Example 1). These materials were mixed for a few minutes using a mortar and pestle. The cathode composite was then incorporated into an electrochemical cell.

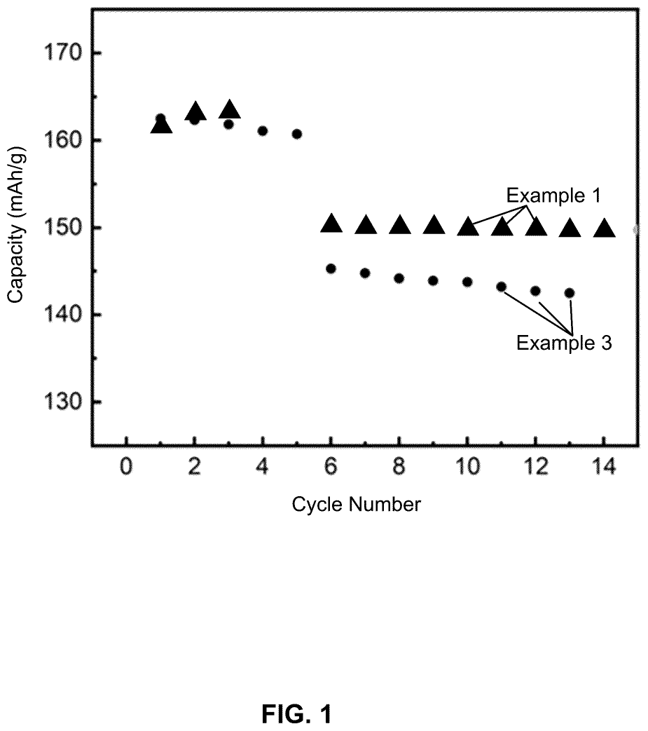

As shown by FIG. 1, the electrochemical cell containing an uncoated NMC cathode material and sulfide-based solid electrolyte as in Example 3 showed a rapid decrease in electrochemical performance by a decrease in overall cell capacity. However, the electrochemical cell using the cathode material of Example 1 showed increased cell capacity.

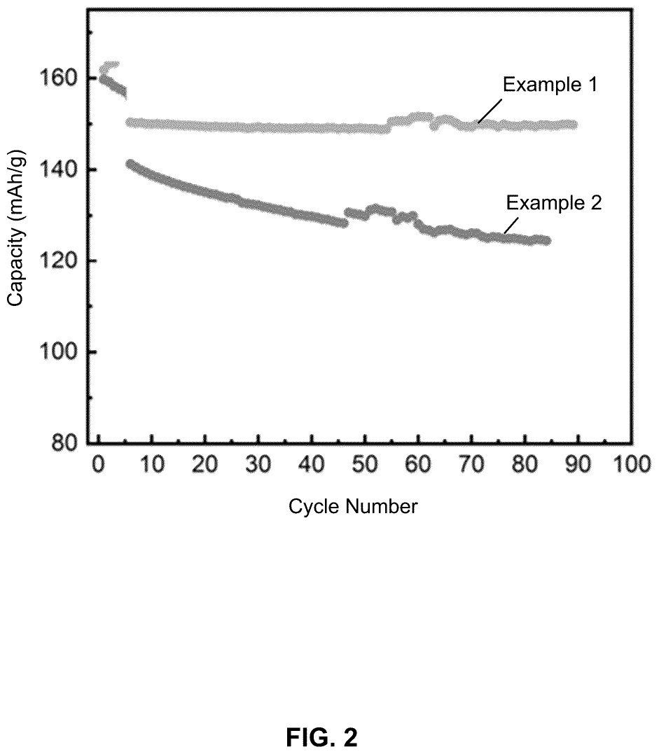

This surprising difference is also shown by comparing Example 1 and Example 2. FIG. 2 shows that the cathode of Example 1 using the LiOH maintains a higher capacity than the cathode of Example 2 using Li₂CO₃.

### Example 4

A cathode composite of was made containing 66.2 wt % NMC cathode active material, 2.5 wt % carbon conductive additive, 30.5 wt % sulfide-based solid electrolyte material, and 0.8 wt % LiOH powder. The composite was made by adding all of the materials into a mortar and pestle. The materials were mixed with the pestle for a few minutes to form a homogeneous cathode composite. The cathode composite was then incorporated into an electrochemical cell.

### Example 5

A cathode composite was made containing 65.0 wt % NMC cathode active material, 2.5 wt % carbon conductive additive, 30.5 wt % sulfide-based solid electrolyte material (the same as used in Example 1), and 2.0 wt % LiOH powder. This composite was made by adding all of the materials into a mortar and pestle. All the materials were then mixed with the pestle for several minutes to form a homogeneous cathode composite. The cathode composite was then incorporated into an electrochemical cell.

### Example 6

A cathode composite was made containing 63.6 wt % NMC cathode active material, 2.5 wt % carbon conductive additive, 30.5 wt % sulfide-based solid electrolyte material (the same as used in Example 1), and 3.4 wt % LiOH powder. This composite was made by adding all of the materials into a mortar and pestle. All the materials were then mixed for several minutes to form a homogeneous cathode composite. The cathode composite was then incorporated into an electrochemical cell.

### Example 7

A cathode composite was made containing 60.3 wt % NMC cathode active material, 2.5 wt % carbon conductive additive, 30.5 wt % sulfide-based solid electrolyte material (the same as used in Example 1), and 6.7 wt % LiOH powder. This composite is made by adding all of the materials into a mortar. All the materials are then mixed for several minutes to form a homogeneous cathode composite. The cathode composite was then incorporated into an electrochemical cell.

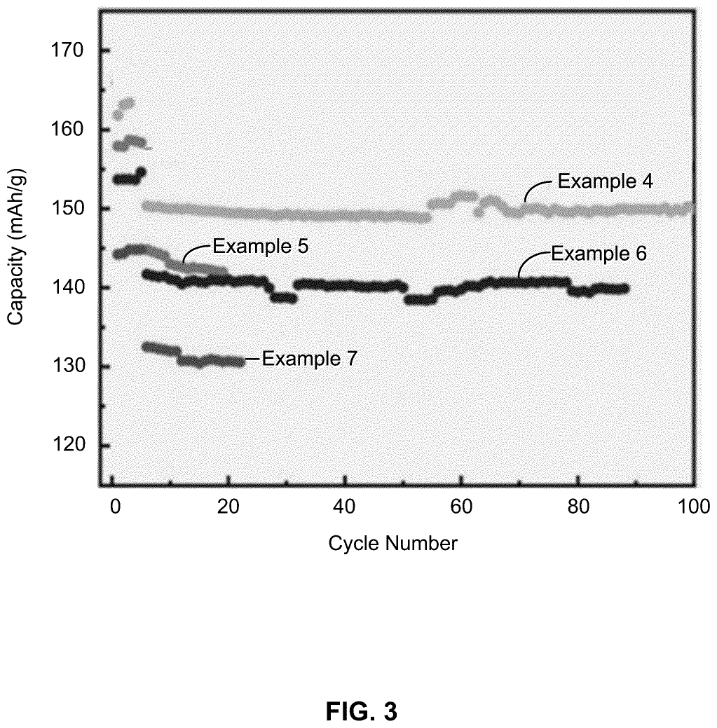

The capacity of the cells using the cathode composites of Examples 4-7 are shown in FIG. 3. As can be seen, Example 4 showed the highest capacity of the cells.

### Example 8—Comparative

A cathode composite was made containing 67 wt % uncoated NMC cathode active material, 2.5 wt % carbon conductive additive, and 30.5 wt % sulfide-based solid electrolyte material (the same as used in Example 1). This composite was made by mixing all material together using a mortar and pestle for several minutes. The cathode composite was then incorporated into an electrochemical cell.

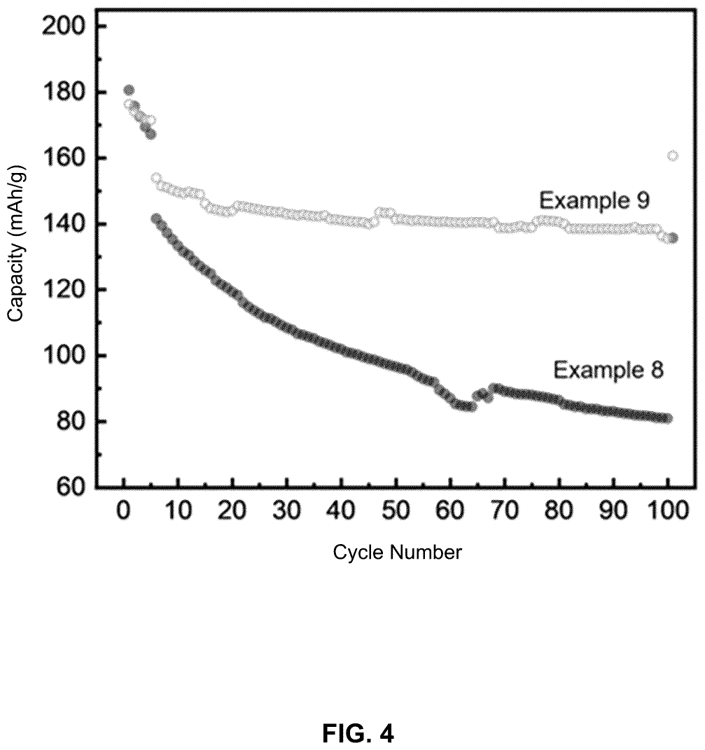

As compared with the cell of Example 7 shown in FIG. 3, the cell of Example 8 as shown in FIG. 4 initially had a higher capacity. However, the cell of Example 7 maintained a capacity of about 130 mAh/g after 20 cycles, whereas the cell of Example 8 dropped to a capacity of about 120 mAh/g after about 20 cycles. This shows that the addition of the addition of the hydroxide material reduces the decrease in capacity after cycling the cell numerous times.

### Example 9

A cathode composite was made containing 64 wt % uncoated NMC cathode active material, 2.5 wt % carbon conductive additive, 30.5 wt % sulfide-based solid electrolyte material (the same as used in Example 1), and 3.0 wt % Zirconia Hydroxide. This composite is made by mixing all material together using a mortar and pestle where the mixing took place for several minutes. The cathode composite was then incorporated into an electrochemical cell.

As shown in FIG. 4, the capacity of the cell including the cathode composite of Example 9 (including zirconium hydroxide) was much higher than the composite of Example 8, which did not include a metal hydroxide.

What is claimed is:

1. A cathode active material having a surface, wherein at least 5% of the surface is coated by a metal hydroxide.

2. The cathode active material of claim 1, where the cathode active material comprises a nickel-manganese-cobalt (NMC) cathode active material.

3. The cathode active material of claim 1, wherein the metal hydroxide comprises lithium hydroxide or zirconium hydroxide.

4. The cathode active material of claim 1, wherein at least 50% of the surface of the cathode active material is coated by the metal hydroxide.

5. The cathode active material of claim 1, wherein the surface of the cathode active material is fully coated by the metal hydroxide.

6. A cathode composite comprising a conductive additive, a solid electrolyte material, a metal hydroxide, and a cathode active material, wherein the metal hydroxide is distributed throughout the cathode composite.

7. The cathode composite of claim 6, where the conductive additive comprises carbon.

8. The cathode composite of claim 6, wherein the solid electrolyte material is an Argyrodite sulfide-based solid electrolyte.

9. The cathode composite of claim 6, further comprising a binder.

10. The cathode composite of claim 6, wherein the cathode active material is in the form of particles and each of the particles has a surface, and at least 5% of the surface of the cathode active material particles is coated by the metal hydroxide.

11. The cathode composite of claim 10, wherein at least 15% of the surface of the cathode active material particles is coated by a lithium containing metal hydroxide.

12. The cathode composite of claim 10, wherein at least 25% of the surface of the cathode active material particles is coated by a lithium containing metal hydroxide.

13. The cathode composite of claim 10, wherein at least 50% of the surface of the cathode active material particles is coated by a lithium containing metal hydroxide.

14. The cathode composite of claim 6, wherein the conductive additive is in the form of particles and each of the particles has a surface, wherein at least 5% of the surface of the conductive additive particles is coated by the metal hydroxide.

15. The cathode composite of claim 6, wherein the metal hydroxide has an average particle size of 10 um or less.

16. The cathode composite of claim 6, where the metal hydroxide has an average particle size of 5 μm or less.

17. The cathode composite of claim 6, where the metal hydroxide has an average particle size of 1 μm or less.

18. The cathode composite of claim 6, wherein the cathode active material comprises a nickel-manganese-cobalt (NMC) cathode active material.

19. The cathode composite of claim 6, wherein the solid electrolyte comprises an Argyrodite sulfide-based solid electrolyte.

20. A solid-state battery comprising the cathode composite of claim 6.

21. A solid state battery comprising a cathode composite, the cathode composite comprising a conductive additive, a solid electrolyte material, a metal hydroxide, and a cathode active material, wherein the metal hydroxide is distributed throughout the cathode composite.

22. The solid state battery of claim 21, where the conductive additive comprises carbon.

23. The solid state battery of claim 21, where the solid electrolyte material comprises an Argyrodite sulfide-based solid electrolyte.

24. The solid state battery of claim 21, wherein the cathode active material is in the form of particles and each of the particles has a surface, and at least 5% of the surface of the cathode active material particles is coated by the metal hydroxide.

25. The solid state battery of claim 21, wherein the cathode active material comprises a nickel-manganese-cobalt (NMC) cathode active material.

26. The solid state battery of claim 21, wherein the cathode composite further comprises a binder.

27. A method for making a cathode composite comprising:
combining a cathode active material and a metal hydroxide, wherein the cathode active material is in the form of particles and each of the particles has a surface, and wherein at least 5% of the surface of the cathode active material particles is coated by the metal hydroxide as a result of the combining; and
combining the coated cathode active material with a conductive additive, a solid electrolyte, and a binder to form a cathode composite.

28. A method for making a cathode composite comprising:
combining a cathode active material, a metal hydroxide, a conductive additive, a solid electrolyte, and a binder to form the cathode composite, wherein the combining results in the metal hydroxide being dispersed throughout the cathode composite.

29. The method of claim 28, wherein the cathode active material is coated by a metal hydroxide prior to the combining.

30. A method for making a cathode composite comprising:
combining a cathode active material and a metal hydroxide, wherein the cathode active material is in the form of particles and each of the particles has a surface, and wherein at least 5% of the surface of the cathode active material particles is coated by the metal hydroxide as a result of the combining; and
combining the coated cathode active material with a conductive additive, a solid electrolyte, a binder and an additional amount of the metal hydroxide to form a cathode composite.
